(19) United States
(12) Patent Application Publication
(10) Pub. No.: US 2008/0079703 A1
(43) Pub. Date: Apr. 3, 2008

(54) Method of driving the display device and display device

(75) Inventor: Yutaka Yamagami, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/905,362

(22) Filed: Sep. 28, 2007

(30) Foreign Application Priority Data
Sep. 29, 2006 (JP) 2006-267220

(51) Int. Cl. G09G 5/00

(52) U.S. Cl. 345/205

(57) ABSTRACT

According to an embodiment of the present invention, a method of driving a display device to drive plural pixels arranged on the same line in a time-division manner in a driving period of the line, includes: changing a time-division driving order of a plurality of pixels to an order in a previous frame for each frame and driving predetermined pixels of the plurality of pixels at a first timing in the one driving period; driving a first pixel driven at the first timing with an inverted polarity with respect to a polarity of a drive voltage of a previous frame; and driving a second pixel adjacent to the first pixel out of the plurality of pixels, which is driven at a second timing after the first timing with the same polarity as the polarity of a drive voltage of a previous frame.

### BACKGROUND OF THE INVENTION

1. Field of the Invention

The present invention relates to a method of driving a display device and a display device, and more specifically to a method of driving a display device based on a driving system that supplies a drive voltage on a time-division basis, and a display device.

2. Description of Related Art

A segment type liquid crystal display device that displays characters such as text data has been brought into practical use earlier, but nowadays, a dot matrix type liquid crystal display device have been widely used. The dot matrix type liquid crystal display device is a display device where fine rectangular pixels are arranged in matrix. Each pixel is a capacitor in electric terms (hereinafter referred to as “pixel capacitor”), and a liquid crystal material is filled between two electrodes. One electrodes of each pixel electrode are electrically connected and thus called “common electrode”. Further, the other electrodes of each pixel are electrically independent of each other and called “pixel electrode”. A thin film transistor (TFT) is connected to each pixel electrode. The TFT selectively applies a drive voltage to each pixel electrode. This configuration enables application of an arbitrary voltage to each pixel capacitor, so light transmittance can be controlled for each pixel.

FIG. 17 schematically shows the electrical configuration of a dot matrix type liquid crystal display device of the related art. As shown in FIG. 17, the liquid crystal display device of the related art includes a pixel capacitor CL, a thin film transistor TFT, gate lines G1, G2, and G3, source lines S1, S2, S3, and S4, and a common electrode COM. Each pixel capacitor CL is paired with each TFT. Gate terminals of the TFTs are connected to gate lines G1, G2, and G3 on the line basis, and the TFTs are collectively controlled on the line basis. Further, source terminals of the TFTs are connected to source lines S1, S2, S3, and S4 on the column basis. Further, drain terminals of the TFTs are connected to each pixel electrode as one electrode of a corresponding pixel capacitor CL.

According to a method of driving the liquid crystal display device of the related art as shown in FIG. 17, a scanning voltage to turn on the TFT is first supplied to a gate line of any one line to thereby turn on all TFTs connected to the gate line. As a result, a drive voltage is supplied to each pixel capacitor CL of the line from the source line through the TFTs in an on state. After that, the scanning voltage to turn off the TFT is supplied to the gate line of the line to thereby turn off all TFTs connected to the gate line. The above operation is performed on all lines one by one to display one frame. As described above, a writing operation to the pixel capacitor CL is executed on the line basis, so a period necessary to rewrite data to a pixel capacitor CL to which data has been written is almost equal to the total sum of periods for writing data to the pixel capacitors CL on all lines of one frame. During this writing period, the pixel capacitor CL needs to continuously hold the written voltage, and the pixel needs to keep a predetermined transmittance corresponding to the hold voltage as requisite performance of the dot matrix type liquid crystal display device.

The dot matrix type liquid crystal display device has rapidly become popular because of its high performance to display an arbitrary image or text data. In particular, in recent years, a performance of the dot matrix type liquid crystal display device has been dramatically improved to enable a large screen size, a high definition, and a multicolor display. However, along with the improvements in performance, problems that might not be considered in the related art arise, and various improvements have been made as a countermeasure against the problems. For example, due to the high definition, a distance between a varying potential source such as a source line or gate line and the pixel capacitor CL is decreased, with the result that a parasitic capacitance increases, and an influence of the coupling is increased. In spite thereof, a demand to increase an accuracy of a pixel voltage grows more and more due to the multicolor. The influence of the coupling is described below based on an equivalent circuit of the pixel capacitor and the parasitic capacitance as shown in FIG. 18.

As shown in FIG. 18, the equivalent circuit includes a pixel capacitor CL, a parasitic capacitance CP, a thin film transistor TFT, a source line S, a gate line G, a common electrode COM, a pixel electrode A, and a varying potential source P. The TFT is turned on to charge the pixel capacitor CL with a drive voltage. At this time, a voltage of the pixel electrode A applied to the common electrode COM is denoted by VA1. After the completion of charging the pixel capacitor CL, the TFT is turned off. After that, the pixel capacitor CL holds VA1. In this state, if a voltage of the varying potential source is changed from VP1 to VP2, a voltage of the pixel capacitor CL is changed from VA1 to VA2 due to coupling. If no charges are input/output to/from the pixel electrode A, the following expression is established.

VA1×CL+(VA1−VP1)×CP=VA2×CL+(VA2−VP2)CP (1)

VA2 is derived from Expression (1) as follows.

VA2=VA1+(VP2−VP1)×CP/(CL+CP) (2)

### In this example, provided that variations in voltage at a point P are represented by ΔVP=VP2−VP1, Expression (2) is given as below.

VA2=VA1+ΔVP×CP/(CL+CP) (3)

That is, a potential of the pixel electrode A is changed by ΔVP×CP/(CL+CP) due to the fact that the varying voltage source P is changed by ΔVP. This leads to a problem that a voltage held in the pixel capacitor CL that needs to hold the voltage VA1 is changed.

The varying potential source P in the equivalent circuit of FIG. 18 is a source line or gate line in the actual dot matrix type liquid crystal display device. In particular, a scanning voltage to be supplied to the gate line has a larger amplitude than that of the drive voltage. Hence, voltage change ΔVP of the varying voltage source P is large, and variations in voltage held in the pixel capacitor CL increases. Further, voltage change due to the scanning voltage always influences a predetermined polar direction with respect to the pixel voltage held in the pixel capacitor CL. This causes reduction in display quality such as flicker or degradation of a liquid crystal material.

As a solution to the problem, for example, Japan Patent No. 2989952 discloses means to give offsets inverse to a change in pixel voltage due to the coupling to the drive voltage to cancel out the change in pixel voltage due to the coupling.

Further, a problem accompanying improvements in performance of the dot matrix type liquid crystal display device is not only a problem regarding a display quality. An increase in the number of pixels in accordance with a large screen size or high definition causes a problem in a manufacturing process. If the number of pixels is increased, it is necessary to increase the number of source driving circuits. Thus, how to increase an integration degree of a liquid crystal driver IC or a line density at a junction between the driver IC and the liquid crystal display panel is an important problem, with the result that it is difficult to increase a screen size and image definition.

As a solution to the problem, for example, Japanese Unexamined Patent Application Publication No. 2006-72382 (ino) discloses a driving method that supplies a drive voltage on the time-division fashion. The publication of Ino describes a method of distributing a voltage output from the source driver to plural source lines with a multiplexer mounted onto a liquid crystal display panel. That is, in the liquid crystal display device described in the publication of ino, the drive voltage is multiplexed in the time-division direction, with the result that one physical line channel at a junction between the source driver and the liquid crystal display panel has functions of plural source drive channels. A multiplexer circuit can be mounted onto the liquid crystal display panel by a TFT technique. Further, in recent years, switching characteristics can be improved by a low-temperature polysilicon technique.

With the above time-division driving technique, for example, in the color liquid crystal display device, drive voltages corresponding to pixels of three primary colors, R, G, and B are successively supplied from one source driving circuit of the source driver. Thus, it is possible to reduce the number of source driving circuits to be mounted onto the source driver, and the number of output lines passing through the junction between the driver IC and the liquid crystal display panel down to ⅓, so it is possible to manufacture a liquid crystal display device with more pixels.

However, in the time-division driving system necessary for a large screen size and high definition, pixels driven at different timings coexist on the same gate line, so a new problem of parasitic capacitance coupling between adjacent pixels arise. In this example, in the time-division driving system, an influence of the parasitic capacitance coupling between adjacent pixels is described in detail below with reference to an equivalent circuit of FIG. 19. As shown in FIG. 19, the equivalent circuit includes a pixel capacitor CL1, CL2, and CL3, a parasitic capacitance between adjacent pixels CP, a thin film transistor TFT1, TFT2, and TFT3, a source line S, a gate line G1, G2, and G3, a common electrode COM, and a pixel electrode A, P, and Q. Incidentally, in this example, capacitances of the pixel capacitors CL1, CL2, and CL3 are all CL.

In the case of writing voltage to the three pixel capacitors CL2, CL1, and CL3 of FIG. 19 in this order, attentions are paid to how a drive voltage of the pixel capacitor CL2 to which the voltage is first written is changed due to an operation of writing a voltage to the pixel capacitors CL1 and CL3. Incidentally, considering a voltage change of the pixel capacitor CL2, in FIG. 19, an influence of coupling between the pixel capacitor arranged on the left side of the pixel electrode P and the pixel capacitor CL2 arranged on the right side of the pixel electrode Q is small, so description thereof is omitted here.

The TFT2 is turned on to write a voltage to the pixel electrode A. A voltage of the pixel electrode A is denoted by VA1. Further, a voltage of the pixel electrode P is denoted by VP1, and a voltage of the pixel electrode Q is denoted by VQ1. Each of these voltages is a voltage relative to the common electrode COM. Then, after the TFT2 is turned off, the TFT1 is subsequently turned on. If VA1, VP1, and VQ1 become VA2, VP2, and VQ2, no charges are input/output to/from the pixel electrode A and pixel electrode Q, so the following two expressions are established.

(VA1−VP1)×CP+VA1×CL+(VA1−VQ1)×CP=(VA2−VP2)×CP+VA2×CL+(VA2−VQ2)×CP (4)

(VQ1−VA1)×CP+VQ1×CL=(VQ2−VA2)×CP+VQ2×CL (5)

In this example, VP2 represents a drive voltage itself and is a known value, so the other voltages, VA2, VQ2 are derived from simultaneous equation of Expressions (4) and (5) as follows.

VA2=VA1+(VP2−VP1)×CP×(CP+CL)/[(2CP+CL)×(CP+CL)−CP²] (6)

VQ2=VQ1+(VP2−VP1)×CP²/[(2CP+CL)×(CP+CL)−CP²] (7)

If the parasitic capacitance CP is much smaller than that of the pixel capacitor CL, Expression (6) and Expression (7) are approximated as follows.

$$\begin{matrix}\begin{matrix}V A 2 = V A 1 + ( V P 2 - V P 1 ) \times ( C P + C L ) / ( C P + 3 C L ) \\ = V A 1 + Δ V P \times ( C P + C L ) / ( C P + 3 C L )\end{matrix} & ( 8 ) \\ \begin{matrix}V Q 2 = V Q 1 + ( V P 2 - V P 1 ) \times C P / ( C P + 3 C L ) \\ = V Q 1 + Δ V P \times C P / ( C P + 3 C L )\end{matrix} & ( 9 )\end{matrix}$$

### In Expression (8), ΔVP×(CP+CL)/(CP+3CL) in the second term on the right-hand side represents an influence (variations) on a voltage of the pixel electrode A due to an operation of writing a voltage to a pixel electrode adjacent to the pixel electrode A.

After that, the TFT1 is turned off, and then, the TFT3 is turned on to thereby write a voltage to the pixel electrode Q. As a result, if VA2, VP2, and VQ2 become VA3, VP3, and VQ3, the following two expressions are similarly established.

VA3=VA2+(VQ3−VQ2)×(CP+CL)/(CP+3CL) (10)

VP3=VP2+(VQ3−VQ2)×CP/(CP+3CL) (11)

### In this example, if the voltage change of the pixel electrode Q s expressed by ΔVQ=VQ3−VQ2, Expression (10) and Expression (11) are modified to Expressions (12) and (13) as below.

VA3=VA2+ΔVQ×(CP+CL)/(CP+3CL) (12)

VP3=VP2+ΔVQ×CP/(CP+3CL) (13)

The voltage of the pixel electrode A after a voltage is written to the pixel electrode P and Q in order is expressed as follows based on Expression (8) and Expression (12).

$$\begin{matrix}V A 3 = V A 2 + Δ V Q \times ( C P + C L ) / ( C P + 3 C L ) \\ = V A 1 + ( Δ V P + Δ V Q ) \times ( C P + C L ) / ( C P + 3 C L )\end{matrix} \qquad ( 14 )$$

In Expression (14), (ΔVP+ΔVQ)×(CP+CL)/(CP+3CL) as the second term on the right-hand side expresses an influence of the operation of writing a voltage to right and left pixel electrodes adjacent to the pixel electrode A on the pixel electrode A. Hence, the more pixel voltages of the right and left pixel electrodes vary, the more an influence of the parasitic capacitance coupling. On the contrary, a voltage finally written to the pixel electrode is not influenced by the coupling at all.

This phenomenon is explained also with reference to a waveform of a three time-division driving system of the related art as shown in FIG. 20. FIG. 20 represents an example of driving pixels of each of R, G, and B colors of a color liquid crystal display panel based on the three time division driving system. In FIG. 20, S represents a drive voltage waveform, COM represents common voltage waveform, RSW, GSW, and BSW represent waveforms of control signals to be written to R, G, and B pixels, and VR, VG, and VB represent waveforms of a voltage charged to the R, G, and B pixel capacitors. In this example, in the drive voltage waveforms, the voltage is set to have a large potential difference from a common voltage such that the maximum drive voltage is applied to the R and B pixels; the voltage is set equal to the common voltage such that 0 V is applied to the G pixel. Incidentally, in the illustrated example of FIG. 20, the common voltage is at a fixed level, but there have been used the other driving methods where a voltage of a rectangular waveform in opposite phase with a drive voltage is used as a common voltage to thereby increase a drive voltage relative to the common voltage.

As apparent from FIG. 20, the voltage VB of the B pixel that is finally driven is not changed from the write voltage in each frame. However, the voltage VR of the R pixel and the voltage VG of the G pixel are changed in accordance with the voltage VB of the B pixel, and the changed voltage is not adjusted until the next frame. Further, if the drive voltage waveform of FIG. 20 is not obtained, an influence on the voltage VR of the R pixel and an influence of the voltage VG of the G pixel become, of course, different.

A measure for suppressing a change in pixel voltage due to the time-division writing order has been considered. For example, in the technique of Japanese Unexamined Patent Application Publication No. 2005-92176 (Kitani et al.), each time a new gate line is selected, if a voltage of a selected source line in a segment from the multiplexer to each pixel is abruptly changed, such problems that the voltage of an adjacent source line not selected and a voltage held in the pixel connected to the source line are changed are solved. To be specific, Kitani et al. describe a driving method that first drives a pixel a driving polarity of which is inverted each time a new gate line is selected without inverting a driving polarity of a pixel adjacent to the pixel concerned.

The driving method of Kitani et al. reduces a coupling capacitance between source lines in a portion common to the plural source lines, that is, in the segment from the multiplexer to each pixel. Thus, if the source lines extend in parallel for a long distance, for example, this technique is supposedly effective for a relatively large liquid crystal display device used as a monitor screen of a TV or computer.

However, in a relatively small liquid crystal display device used for a cell phone, source lines do not extend in parallel for a long distance. Thus, an influence of a polarity inverted in a line period is small, and it is necessary to adjust a coupling capacitance relative to the pixel capacitor driven in a frame period. However, a coupling capacitance between pixel capacitors due to an inversion of a driving polarity for each frame is not considered at all in the publication of Kitani et al.

The aforementioned phenomenon occurs due to the fact that two pixels arranged at such an interval that causes a non-negligible parasitic capacitance are driven at different timings. Hence, in a time-division driving system that supplies a drive voltage on the time-division basis, the above problem arises. Further, as apparent from expressions used for describing the equivalent circuit of FIG. 19, an influence of the coupling parasitic capacitance varies depending on voltage changes ΔVP and ΔVQ of adjacent pixels. The voltage changes ΔVP and ΔVQ are not generally constant, so the above problems are not solved only by giving an offset to the drive voltage. As described above, in the time-division driving method of the liquid crystal display device of the related art, when a pixel voltage written to the pixel capacitor is held, a coupling parasitic capacitance formed in the varying potential source around the pixel influences a pixel voltage held in the pixel capacitor, resulting in a problem that the display quality lowers.

### SUMMARY

According to an aspect of the present invention, a method of driving a display device to drive plural pixels arranged on the same line in a time-division manner in a driving period of the line, includes: changing a time-division driving order of a plurality of pixels to an order in a previous frame for each frame and driving predetermined pixels of the plurality of pixels at a first timing in the one driving period; driving a first pixel driven at the first timing with an inverted polarity with respect to a polarity of a drive voltage of a previous frame; and driving a second pixel adjacent to the first pixel out of the plurality of pixels, which is driven at a second timing after the first timing with the same polarity as the polarity of a drive voltage of a previous frame. Hence, a polarity of a pixel to which a voltage is written next is not inverted, making it possible to prevent such a situation that a drive voltage held in a pixel to which a voltage is written first is changed due to a parasitic capacitance between adjacent pixel electrodes.

A display device according to another aspect of the invention includes: a plurality of pixel electrodes arranged on the same line; a plurality of signal lines connected to the plurality of pixel electrodes in a one-to-one correspondence; and a driving circuit to change a time-division driving order of a plurality of signal lines to an order in a previous frame for each frame and driving predetermined signal lines of the plurality of signal lines at a first timing in the one driving period, drive a first signal line driven at the first timing with an inverted polarity with respect to a polarity of a drive voltage of a previous frame, and drive a second signal line adjacent to the first signal line out of the plurality of signal lines, which is driven at a second timing after the first timing with the same polarity as the polarity of a drive voltage of a previous frame. Hence, a polarity of a pixel to which a voltage is written next is not inverted, making it possible to prevent such a situation that a drive voltage held in a pixel to which a voltage is written first is changed due to a parasitic capacitance between adjacent pixel electrodes.

According to the present invention, it is possible to provide a method of driving a display device and a display device, which can prevent such a situation that a voltage held in the pixel capacitor is changed due to a coupling capacitance of parasitic capacitances between the pixel and an adjacent pixel.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a liquid crystal display device according to a first embodiment of the present invention;

FIG. 2 shows the structure of a pixel of the liquid crystal display device of the first embodiment;

FIG. 3 shows the structure of a junction between a source driver and a liquid crystal display panel of the first embodiment;

FIG. 4 is a control waveform of the liquid crystal display device of the first embodiment;

FIG. 5 is a control waveform of the liquid crystal display device of the first embodiment;

FIG. 6A shows a driving polarity of each pixel of the liquid crystal display device of the first embodiment;

FIG. 6B shows a driving polarity of each pixel of the liquid crystal display device of the first embodiment;

FIG. 6C shows a driving polarity of each pixel of the liquid crystal display device of the first embodiment;

FIG. 6D shows a driving polarity of each pixel of the liquid crystal display device of the first embodiment;

FIG. 7 is a control waveform of a liquid crystal display device according to a second embodiment of the present invention;

FIG. 8 is a control waveform of the liquid crystal display device of the second embodiment;

FIG. 9 is a control waveform of the liquid crystal display device of the second embodiment;

FIG. 10A shows a driving polarity of each pixel of the liquid crystal display device of the second embodiment;

FIG. 10B shows a driving polarity of each pixel of the liquid crystal display device of the second embodiment;

FIG. 10C shows a driving polarity of each pixel of the liquid crystal display device of the second embodiment;

FIG. 11D shows a driving polarity of each pixel of the liquid crystal display device of the second embodiment;

FIG. 11E shows a driving polarity of each pixel of the liquid crystal display device of the second embodiment;

FIG. 11F shows a driving polarity of each pixel of the liquid crystal display device of the second embodiment;

FIG. 12 shows a voltage waveform of the liquid crystal display device of the second embodiment;

FIG. 13 shows the structure of a junction between a source driver and a liquid crystal display panel according to a third embodiment of the present invention;

FIG. 14 shows a control waveform of the liquid crystal display device of the third embodiment;

FIG. 15 shows a control waveform of the liquid crystal display device of the third embodiment;

FIG. 16A shows a driving polarity of each pixel of the liquid crystal display device of the third embodiment;

FIG. 16B shows a driving polarity of each pixel of the liquid crystal display device of the third embodiment;

FIG. 16C shows a driving polarity of each pixel of the liquid crystal display device of the third embodiment;

FIG. 16D shows a driving polarity of each pixel of the liquid crystal display device of the third embodiment;.

FIG. 17 shows the structure of a liquid crystal display device of the related art;

FIG. 18 is an equivalent circuit diagram showing the structure of a pixel of the liquid crystal display device of the related art;

FIG. 19 is an equivalent circuit diagram showing the structure of a pixel of the liquid crystal display device of the related art; and

FIG. 20 shows a voltage waveform of the liquid crystal display device of the related art.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

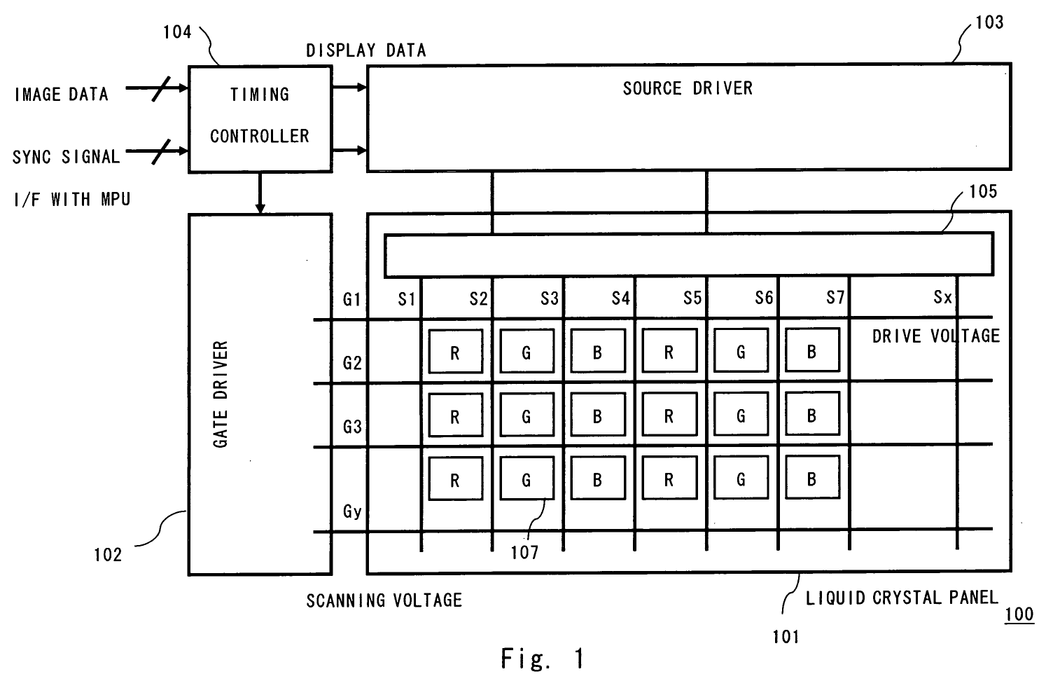

A display device according to a first embodiment of the present invention is described with reference to FIG. 1. An active matrix type TFT liquid crystal display device is described here as an example of a preferred display device for illustrative purposes. FIG. 1 shows the configuration of a liquid crystal display device 100 of this embodiment. In the liquid crystal display device 100 of this embodiment, plural pixels connected to the same gate line are driven on a time division basis. In this embodiment, description is given of an example where outputs from a source drive are distributed to plural source lines with a multiplexer mounted onto a liquid crystal display panel as an example of a time-division driving system to supply a drive voltage in a time-division manner, but the circuit configuration is not limited to this example. Further, a polarity of a drive voltage supplied to each of the plural pixels is inverted at predetermined intervals. Incidentally, the present invention is not limited to an active matrix type liquid crystal display device but is applicable to a display device that drives plural pixels on a column direction and a row direction in a time-division manner.

Further, the present invention is not limited to the operation of driving plural pixels connected to the same gate line in a time-division manner but is applicable to, for example, the case where plural pixels connected to adjacent gate lines are alternately arranged on one line as disclosed in Japanese Unexamined Patent Application Publication Nos. 10-149141 and 2003-149676. That is, in a display device where plural pixels are physically arranged on one line, if the plural pixels arranged on the one line are driven in a time-division manner, the present invention is applicable thereto.

As shown in FIG. 1, the liquid crystal display device 100 includes a liquid crystal display panel 101, a gate driver 102, a source driver 103, a timing controller 104, and a multiplexer 105. The liquid crystal display panel 101 displays an image based on externally input RGB image data. The liquid crystal display panel 101 has a liquid crystal filled between a TFT (Thin Film Transistor) array substrate (not shown) and an opposing substrate (not shown) opposite to the TFT array substrate. The TFT array substrate and the opposing substrate are transparent insulating substrates made of glass or the like.

On the TFT array substrate, plural gate lines (scanning lines) G1, . . . , and Gy are formed at regular intervals in a horizontal direction (row direction). Further, plural source lines (signal lines) S1, . . . , and Sx are formed at regular intervals on the TFT array substrate, in a vertical direction (column direction). The gate lines and the source lines cross each other through an insulating film. Then, a thin film transistor (TFT) as a switching element is formed near an intersection between the gate line and the source line as described below. Further, pixel electrodes are formed between the gate lines and the source lines. The pixel electrodes are made of up a transparent conductive film, for example, ITO (Indium Tin Oxide). A display area of the liquid crystal display panel 101 is composed of the plural pixels 107 arranged in matrix. The TFT has a gate terminal connected to the gate line, a source terminal connected to the source line, and a drain terminal connected to the pixel electrode, respectively. The pixel electrode is supplied with a drive voltage through the TFT from the source line.

On the other hand, on the opposing substrate, for example, black matrix (BM) and a color filter including R, G, and B colored layers. The colored layers are formed between BMs and correspond to the pixel electrodes formed on the TFT array substrate. Further, a common electrode made up of a transparent conductive film such as ITO is formed on the colored layers and the BM. In practice, the common electrode is a transparent electrode formed on almost all of the surface of the opposing substrate opposite to the pixel electrode. The TFT array substrate and the opposing substrate are bonded to each other with a predetermined distance through a sealing member. A liquid crystal is filled between the TFT array substrate and the opposing substrate. Thus, each pixel (pixel capacitor) is a capacitor in electric terms, and a liquid crystal material is filled between two electrodes (the pixel electrode and the common electrode).

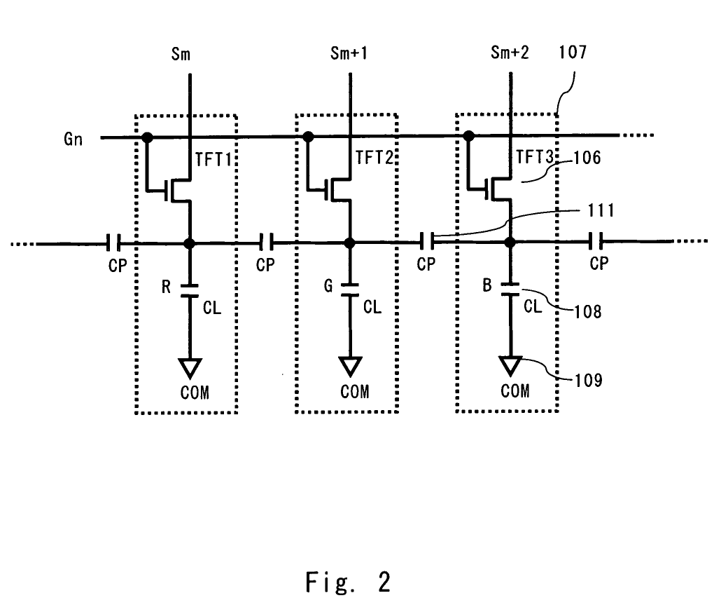

FIG. 2 schematically shows the pixel 107 of the liquid crystal display panel 101. Here, three R, G, and B pixels are illustrated. As shown in FIG. 2, each pixel 107 includes a TFT 106, a pixel capacitor 108, and a common electrode 109. Further, a parasitic capacitance 111 is formed between the adjacent pixel capacitors 108. As described above, gate terminals of each TFT 106 are connected to a common gate line Gn on the line basis. Thus, the TFTs 106 are collectively controlled on the line basis. Further, source terminals of each TFT 106 are connected to source lines Sm, Sm+1, and Sm+2 on the row basis. Further, drain terminals of each TFT 106 are connected to one ends of the pixel capacitor 108. That is, one gate line is connected to the plural TFTs 106 corresponding to the plural pixels electrode. Further, the plural TFT 106 is connected to a corresponding source line.

The pixel capacitor 108 is a capacitive element to hold a drive voltage. The pixel capacitor 108 is supplied with a drive voltage through each TFT 106 from the source lines S1, . . . , and Sx. A level of the drive voltage supplied to the pixel capacitor 108 is changed as appropriate, with the result that an amount of light transmitted through the pixel 107 is changed. The pixel capacitor 108 is connected between the drain terminal of the TFT 106 and the common electrode 109. The common electrode 109 is applied with a voltage as a reference voltage with respect to the drive voltage. Here, description is given of the case where a common voltage is fixed. Incidentally, the present invention is not limited to the above example, and a rectangular-wave voltage in opposite phase with the drive voltage may be used as a common voltage, for example.

In the pixel 107, any of the gate lines G1, . . . , and Gx are applied with a scanning voltage, and the TFT 106 connected to the selected gate line is turned on. The TFT 106 is turned on to thereby apply the drive voltage supplied through the source lines S1, . . . , and Sn to the pixel capacitor 108. Then, if the gate lines G1, . . . , and Gx are not applied with the scanning voltage, the TFT is turned off. The pixel capacitor 108 holds the written drive voltage in one frame until the drive voltage is reapplied. The held drive voltage enables continuous image display on the liquid crystal display panel 101. The gate lines G1, . . . , and Gy are successively applied with a scanning voltage to display the entire display screen.

Further, a polarizing plate (not shown) is bonded to the outer side of the TFT array substrate and the opposing substrate. The polarizing plates bonded to the substrates have an absorption axis in a predetermined direction. Further, a not-shown backlight unit is provided on the rear side of the liquid crystal display panel 101. The backlight unit irradiates planar light to the liquid crystal display panel 101 from the side opposite to an image display side of the liquid crystal display panel 101. As the backlight unit, for example, a typical one including a light source, a light guide plate, and a prism sheet may be used.

The liquid crystal display panel 101 is electrically connected to the gate driver 102 and the source driver 103. An output of the gate driver 102 is connected to a gate terminal of the TFT 106. The gate driver 102 supplies a scanning voltage to the gate lines G1, . . . , and Gy in order and executes on/off control over the TFT 106 connected to each of the gate lines G1, . . . , and Gy.

As the source driver 103, a driver that employs a time-division driving system is used. That is, a drive voltage is multiplexed on the time series, and thus a physical line channel at the junction between the source driver and the liquid crystal display panel has plural source drive channels. In the time-division driving system, an output of one output terminal of the source driver is distributed to plural source lines. Thus, plural source lines are supplied with the drive voltage in a time-division manner during one selection period in which one gate line is supplied with a scanning voltage. In this example, description is given of an example where three RGB pixels connected to the gate line G are driven in three-time division manner. That is, the source driver 103 includes one output circuit for three source lines.

FIG. 3 schematically shows a configuration example of a junction between the source driver 103 and the liquid crystal display panel 101 of this embodiment. As shown in FIG. 3, the source driver 103 includes plural output circuits 110. Incidentally, on the input side of the output circuit 110, a shift register, a data latch circuit, and a D/A converter, which are incorporated in a general source driver are provided although not shown in this example. Further, the liquid crystal display panel 101 includes the multiplexer 105. The multiplexer 105 includes switches SW1, . . . , and SWx corresponding to the source lines S1, . . . , and Sx. In this embodiment, input terminals of the three switches SW are connected to one output terminal of the output circuit 110. For example, input terminals of the three switches SW1, SW2, and SW3 are connected to an output terminal of one output circuit 110. Further, the output terminals of the switches SW are connected to the source lines S1, . . . , and Sx. Incidentally, the multiplexer 105 may be provided into the source driver 103.

The switches SW1, . . . , and SWx are turned on/off under control in accordance with switch control signals RSW1, GSW1, BSW1, RSW2, GSW2, and BSW2 input from the timing controller 104. In this example, the switch control signals RSW1 and RSW2 are signals to execute on/off control over switches connected to a source line connected to an R pixel. For example, the source line S1 connected to the R pixel is controlled in accordance with the switch control signal RSW1. Further, the source line S4 connected to the R pixel is controlled in accordance with the switch control signal RSW2. Likewise, the switch control signals GSW1 and GSW2 are signals to execute on/off control over switches connected to a source line connected to the G pixel. For example, the source line S2 connected to the G pixel is controlled in accordance with a switch control signal GSW1. Further, the source line S5 connected to the G pixel is controlled in accordance with a switch control signal GSW2. Further, the switch control signals BSW1 and BSW2 are signals to execute on/off control over switches connected to a source line connected to the B pixel. For example, the source line S3 connected to the B pixel is controlled in accordance with a switch control signal BSW1. Further, the source line S6 connected to the B pixel is controlled in accordance with a switch control signal BSW2. Thus, in this embodiment, a first pixel group driven with the RSW1, GSW1, and BSW1 and a second pixel group driven with the RSW2, GSW2, and BSW2 are alternately arranged.

An output from the source driver 103 is supplied to a source line selected with the switch control signals RSW1, GSW1, BSW1, RSW2, GSW2, and BSW2 output from the timing controller 104 among three source lines connected to the output. Then, the switches SW1, . . . , and SWx are turned on in one selection period where one gate line is selected. A drive voltage output from the output circuit 110 of the source driver 103 is supplied to the source lines S1, . . . , and Sx through the switches SW1, . . . , and SWx, which are turned on. That is, a drive voltage is supplied to the source lines S1, . . . , and Sx in a time-division manner. That is, plural pixels connected to one gate line are driven in a time-division manner in one selection period where the gate line is applied with a scanning voltage. The order in which a drive voltage is applied to the source lines S1, . . . , and Sx in a time-division manner is changed in accordance with a frame. That is, the order in which plural pixels connected to the same gate line are driven is changed in accordance with a frame. This is described in detail below.

In this embodiment, one output of the source driver 103 is supplied to three source lines of the liquid crystal display panel 101 in a time-division manner. That is, a drive voltage to be supplied to three RGB pixels constituting 1 pixel is output from one output terminal of the source driver 103. For example, three source lines S1, S2, and S3 are supplied with one output of the source driver 103 in one selection period where the gate line G1 is supplied with a scanning voltage. As described above, the source lines S1, . . . , and Sx are connected to a source terminal of the TFT 106. A drive voltage supplied to the source lines S1, . . . , and Sx is supplied to each pixel electrode through the TFT 106 that is turned on by the gate driver 102. As a result, a pixel voltage corresponding to a potential difference between the pixel electrode and the common electrode 109 is applied to each pixel capacitor 108.

At this time, a polarity of the drive voltage supplied to the source lines S1, . . . , and Sx from the source driver 103 is changed in accordance with the order in which a drive voltage is supplied to the above source lines S1, . . . , and Sx. That is, a polarity of the drive voltage supplied to the pixel capacitor 108 of each pixel 107 is changed in accordance with the order in which the pixel 107 connected to the same gate line is driven. At this time, if a drive voltage of a positive polarity is applied to the source lines S1, . . . , and Sx, positive charges are accumulated into the pixel capacitor 108. If a drive voltage of a negative polarity is applied, negative charges are accumulated in the pixel capacitor 108.

The timing controller 104 converts externally supplied digital image data into display data that can be processed with the source driver 103 to output the display data to the source driver 103. Further, the timing controller 104 converts externally input sync signals into various control signals and timing signal, and the signals are supplied to the gate driver 102 and the source driver 103. The sync signals include, for example, dot clock signals of in input cycle of display data corresponding to 1 pixel, horizontal sync signals Hsync, and vertical sync signals Vsync.

To be specific, the timing controller 104 outputs a strobe signal, a polarity-inverted signal, and the above switch control signals RSW1, GSW1, BSW1, RSW2, GSW2, and BSW2 to the source driver 103. The strobe signal is a signal to latch display data to an internal register. Further, the polarity-inverted signal is a signal to determine which of a positive drive voltage and a negative drive voltage with respect to a potential to the common electrode is selected. On the other hand, the timing controller 104 outputs to a start pulse signal, a clock signal and an enable signal to the gate driver. The start pulse signal is used to select a gate line to output a scanning voltage, and the enable signal is used to control the output of a scanning voltage to thereby output a scanning voltage in each gate line in order. Typically, the gate driver 102 outputs a scanning voltage to the first and subsequent lines to scan pixels in each line.

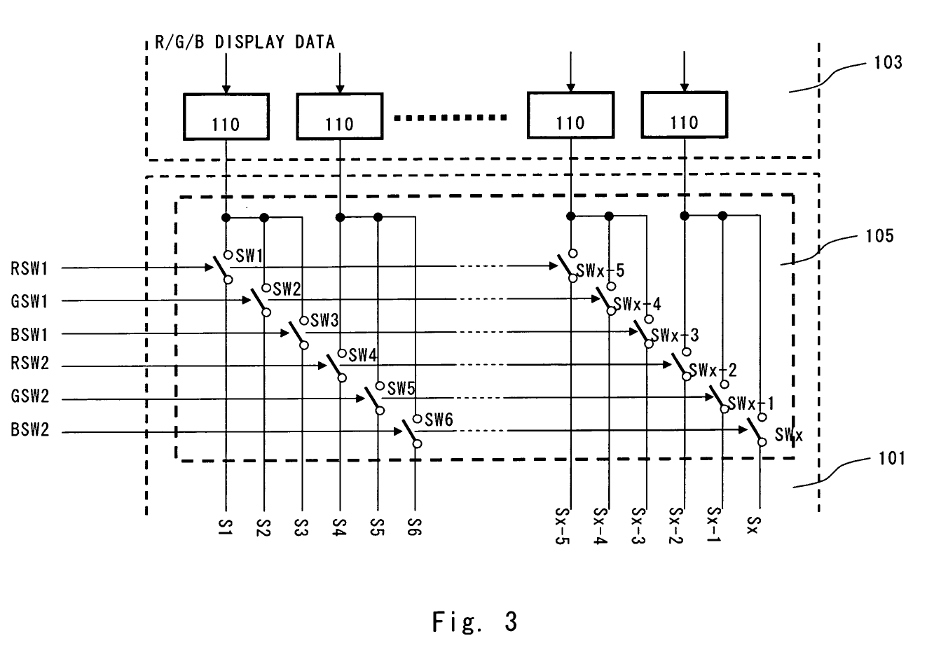

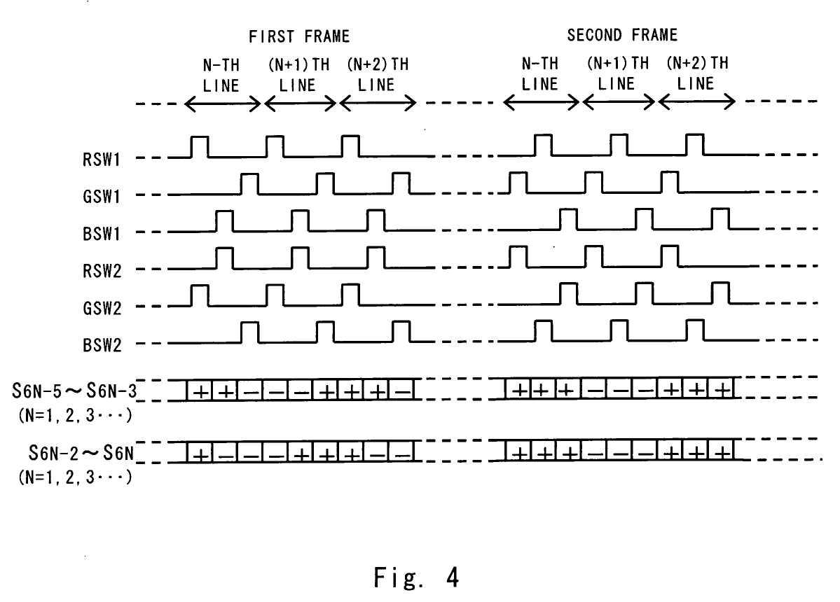

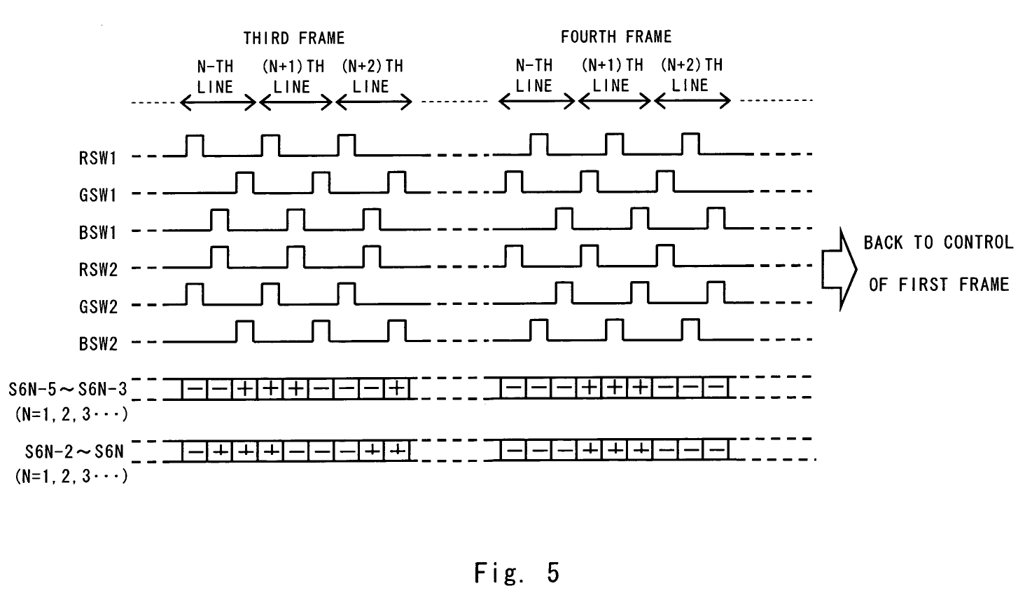

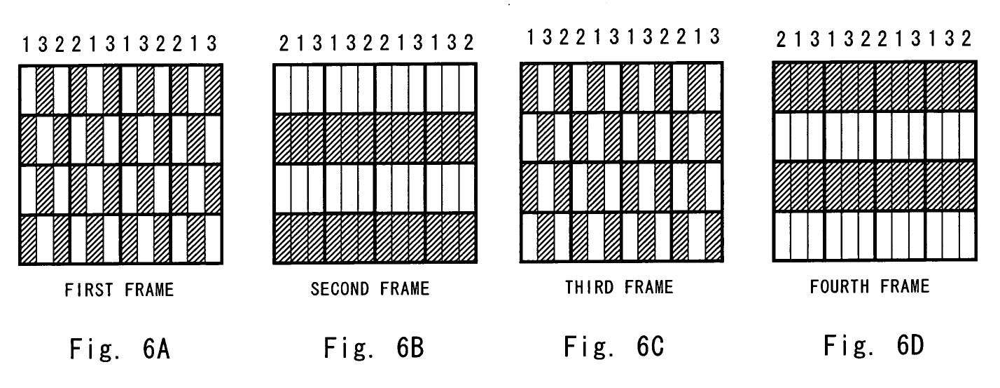

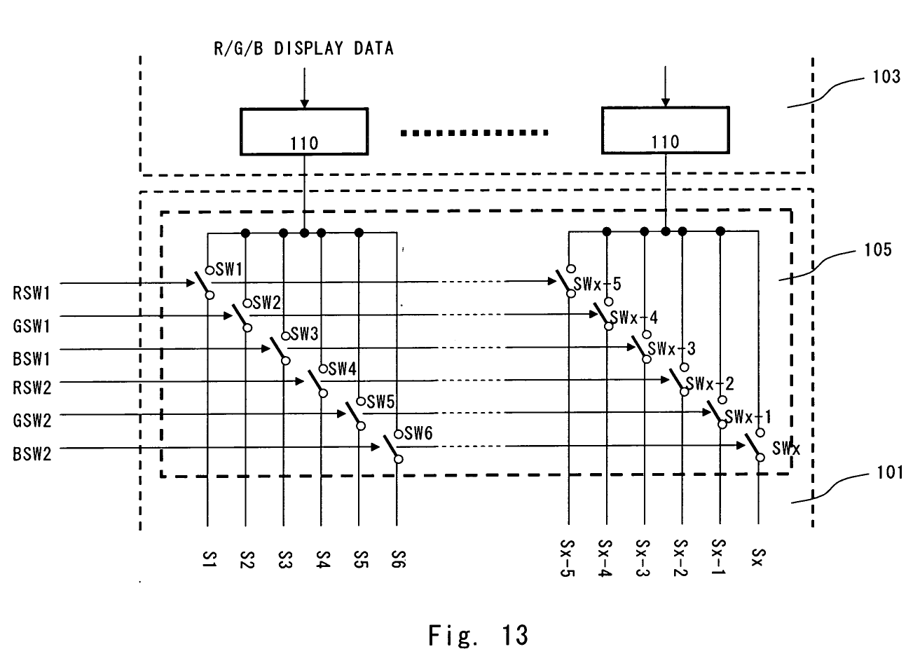

In this example, a driving method of the liquid crystal display device 100 of this embodiment is described in detail with reference to FIG. 4, FIG. 5, and FIGS. 6A to 6D. FIG. 4 and FIG. 5 are timing charts illustrating an example of the driving method of this embodiment. Further, FIGS. 6A to 6D show a drive polarity of each pixel of the liquid crystal display device of this embodiment. In FIGS. 6A to 6D, 12×4 pixels 107 are illustrated, and the box represents the time-division unit. That is, this embodiment describes an example of the three-division driving of RGB pixels. In FIG. 4 and FIG. 5, the RSW1, GSW1, BSW1, RSW2, GSW2, and BSW2 represent switch control pulses to write a drive voltage to each of RGB pixels, and Sm (m=6N−5 to 6N) represents a source drive polarity. Further, in FIGS. 6A to 6D, the white rectangle represents a pixel applied with a positive drive polarity, and the hatched rectangle represents a pixel applied with a negative drive polarity. The numerals in FIGS. 6A to 6D denote the time-division driving order of the plural pixels 107.

As shown in FIG. 4 and FIG. 5, in the present invention, the time-division driving order of the plural pixels 107 connected to the gate line is changed in accordance with a frame in one selection period of one the gate line. That is, the time-division driving order of the plural pixels 107 is changed to the order in a previous frame on the frame basis. Then, some of the plural pixels 107 are driven at a first timing in the one selection period. In this embodiment, the pixels are driven at the first timing in one selection period. That is, the pixel 107 to which the drive voltage is first written is changed in accordance with a frame in one selection period of the gate line.

Then, the pixel 107 to which the drive voltage is first written is driven with an inverted polarity with respect to a polarity of a drive voltage of a previous frame of the pixel 107. That is, a polarity of the drive voltage supplied to the pixel 107 to which the drive voltage is first written is an inverted one of a polarity of the drive voltage supplied to a previous frame of the pixel 107.

Further, in this embodiment, if a voltage has been written to a pixel adjacent to the target pixel 107 in one selection period, the target pixel 107 is driven with the same polarity as a polarity of a frame previous to the target pixel 107. Thus, in this embodiment, the order in which pixels are driven is changed between adjacent RGB pixel groups. Then, the target pixel 107 driven at a second timing subsequent to the pixel 107 to which the drive voltage is first written is drivenwith the same polarity as a polarity of a frame previous to the target pixel 107.

To be specific, as shown in FIG. 4, in the first frame, a first pixel group driven at RSW1, GSW1, BSW1 timings is driven in a time-division manner in a selection period of an n-th line, an (n+1)th line, and an (n+2)th line in the order of R pixel→B pixel→G pixel. Thus, in the first frame, the R pixel in the first pixel group is supplied with a drive voltage at the first timing in one selection period. Then, after the completion of writing a drive voltage to the R pixel in the one selection period, a drive voltage is supplied to the B pixel and the G pixel.

On the other hand, the second pixel group driven at the RSW2, GSW2, and BSW2 timings adjacent to the first pixel group is driven in a time-division manner in a selection period of an n-th line, an (n+1)th line, and an (n+2)th line in the order of G pixel→R pixel→B pixel. Thus, in the first frame, a drive voltage is supplied to the G pixel in the second pixel group adjacent to the first pixel group at the first timing in one selection period. Then, after the completion of writing a drive voltage to the G pixel in the one selection period, a drive voltage is supplied to the R pixel and the B pixel in order. Thus, in the first frame, a drive voltage of a predetermined polarity is supplied to the pixel electrode in the order as shown in FIG. 6A.

Then, in a second frame subsequent to the first frame, the time-division driving order of the first frame is changed. In a selection period of an n-th line, an (n+1)th line, and an (n+2)th line, the first pixel group is driven in a time-division manner in the order of G pixel→R pixel→B pixel. Thus, in the second frame, the G pixel is supplied with a drive voltage at the first timing in one selection period. Then, after the completion of writing a drive voltage to the G pixel in the one selection period, the drive voltage is applied to the R pixel and the B pixel in this order.

On the other hand, the second pixel group driven at the RSW2, GSW2, and BSW2 timings adjacent to the first pixel group is driven in a time-division manner in a selection period of an n-th line, an (n+1)th line, and an (n+2)th line in the order of R pixel→B pixel→G pixel. Thus, the R pixel in the second pixel group adjacent to the first pixel group in the second frame is supplied with a drive voltage at the first timing in one selection period. Then, in the one selection period, after the completion of writing a drive voltage to the R pixel, the drive voltage is supplied to the B pixel and the G pixel in this order.

At this time, if the voltage has been written to a pixel adjacent to the target pixel 107 in one selection period of the gate line, the pixel is driven with the same polarity as a polarity of a previous frame of the pixel 107. A voltage has been written to the G pixel adjacent to the R pixel that is driven second in the first pixel group. Hence, the R pixel adjacent to the G pixel is driven with the same polarity as a polarity of a previous frame Then, the B pixel is driven after the R pixel that is driven after the G pixel, at the first timing in the first pixel group. A voltage has been already written to the G pixel adjacent to the B pixel in the one selection period. Thus, the B pixel is driven with the same polarity as a polarity of a previous frame.

On the other hand, a voltage has not been written to the G pixel adjacent to the B pixel that is driven next in the second pixel group. Further, the R pixel of the first pixel group adjacent to the B pixel in the second pixel group is driven concurrently with the B pixel in the second pixel group. Therefore, the B pixel in the second pixel group can be driven with an inverted polarity with respect to a drive polarity of a previous frame of the pixel. Hence, in this embodiment, the B pixel in the second pixel group is driven with an inverted polarity with respect to a drive polarity of a previous frame of the pixel. Then, the G pixel is driven after the R pixel that is driven at the first timing and the B pixel that is driven at the second timing in the second pixel group. The voltage has been already written to the R and B pixel adjacent to the G pixels. At this time, the G pixel is driven with the same polarity as a polarity of a previous frame of the G pixel.

Thus, in the second frame, pixel electrodes are successively supplied with a drive voltage of a predetermined polarity in the order of FIG. 6B. Thus, even if a drive voltage of a pixel to which the voltage has been written first and held is not influenced by a coupling the parasitic capacitance 111 between adjacent pixels even if a drive voltage is applied to adjacent pixels.

Subsequent third frame and fourth frame are driven in the driving order of the first frame and the second frame as shown in FIG. 5. Further, the drive polarity is obtained as shown in FIGS. 6C and 6D. Thus, plural pixels are alternately driven with an inverted polarity with respect to a polarity of a drive voltage of a previous frame of the pixel. Further, pixels adjacent to the pixel that is driven with the inverted polarity are driven with the same polarity as a polarity of a drive voltage of a previous frame. A polarity of the pixel 107 is changed in accordance with a frame, so all the pixels can be uniformly AC driven. As described above, the plural pixels are alternately driven with an inverted polarity with respect to a polarity of a drive voltage of a previous frame of the pixel, and a polarity is inverted at shorter intervals to thereby suppress flicker. Hence, after the completion of driving the fourth frame, in a subsequent fifth frame, the order and polarity are returned to the time-division driving order and drive polarity of the first frame, and then, this operation is repeated.

As described above, the time-division driving order of the plural pixels 107 is changed to the order in a previous frame on the frame basis. Then, if a voltage has been already written to a pixel adjacent to the target pixel 107, the pixel is driven with the same polarity as a polarity of a frame previous to the target pixel 107. As a result, even if the drive voltage is applied to the adjacent pixel, it is possible to suppress variations in hold voltage. Further, the plural pixels are alternately driven with an inverted polarity with respect to the polarity of a drive voltage of a previous frame.

### Second Embodiment

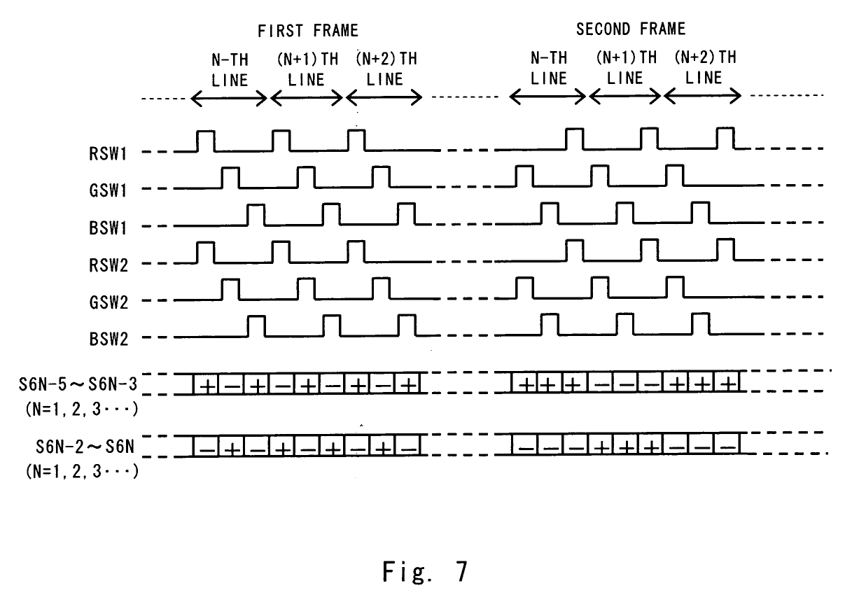

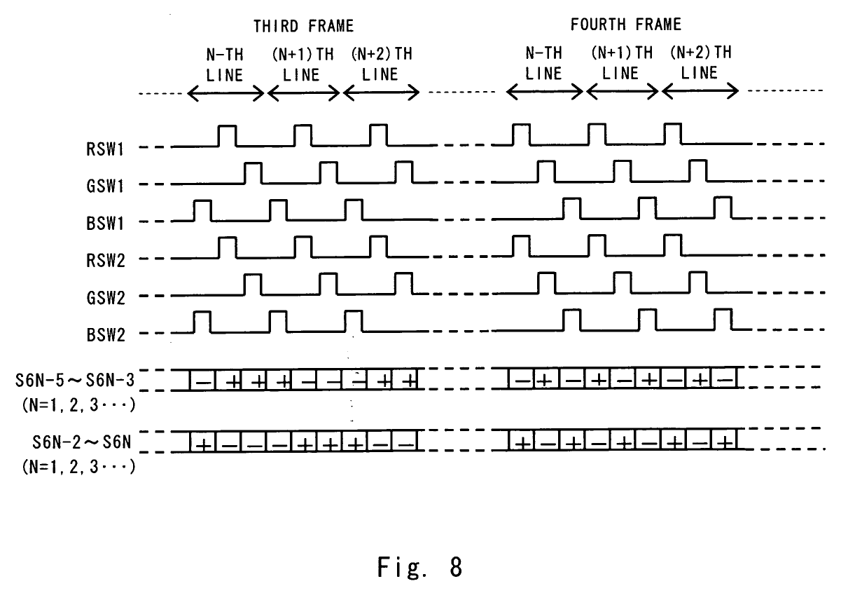

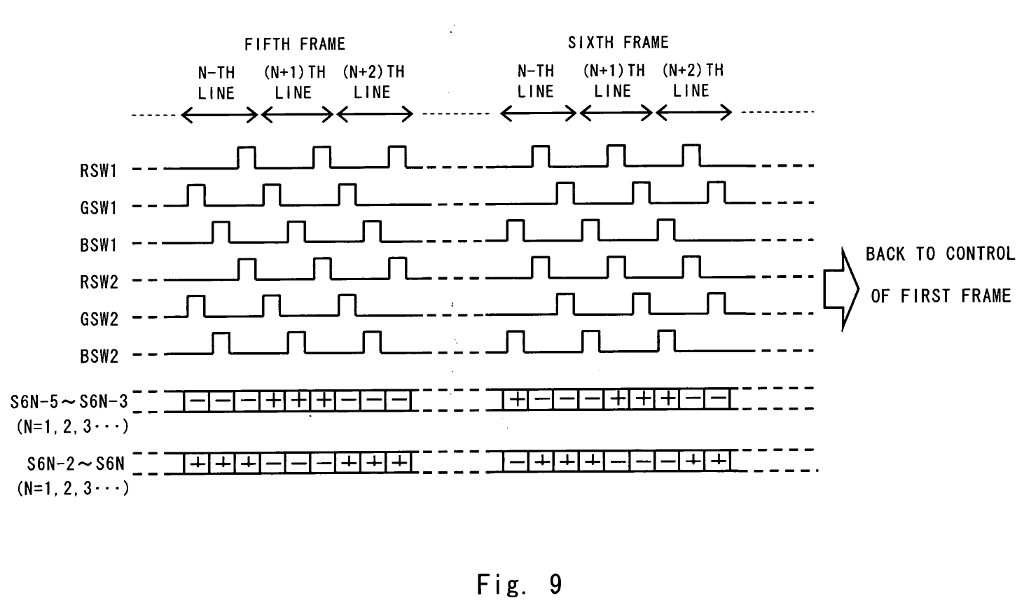

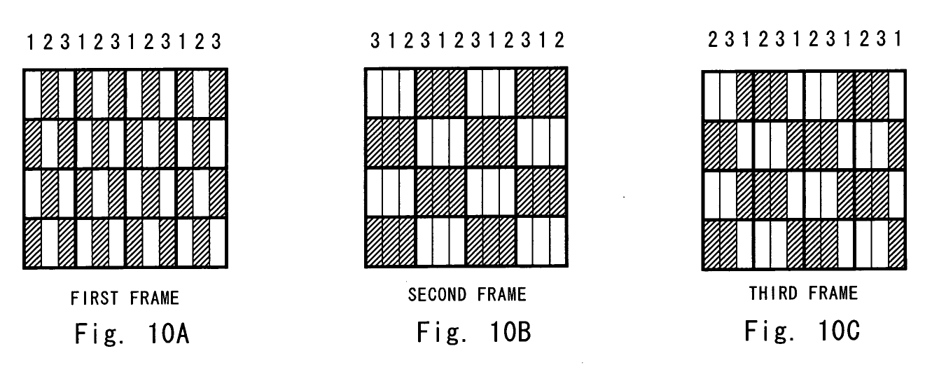

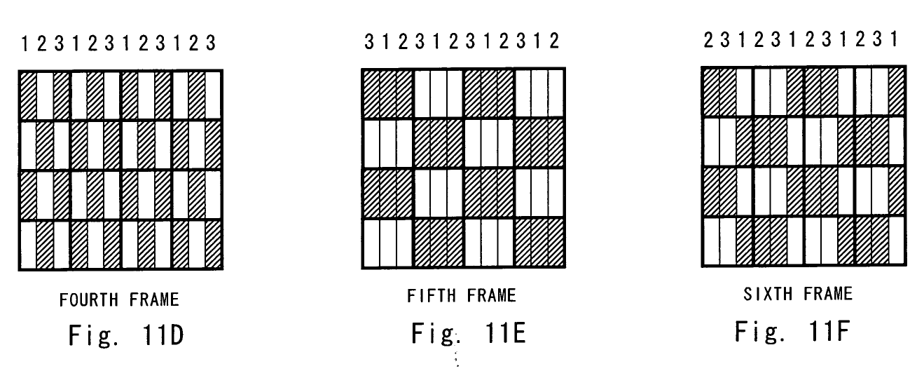

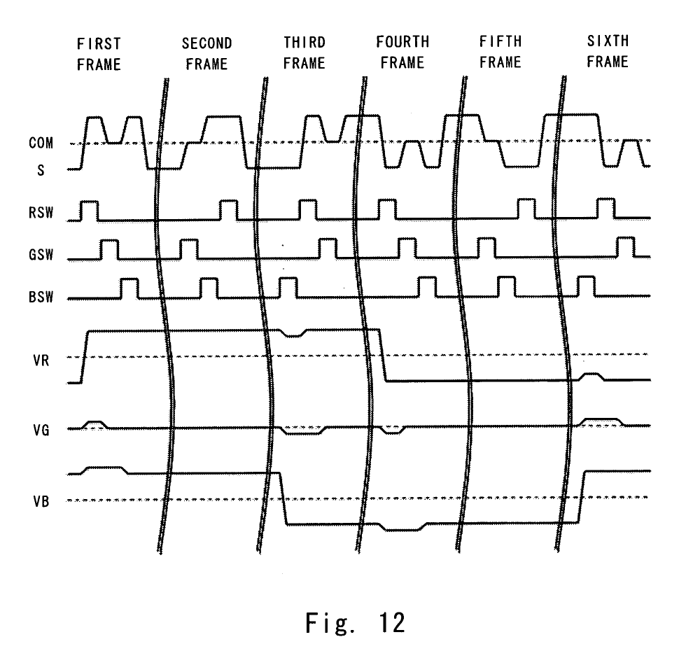

Referring to FIG. 7 to FIG. 12, a driving method according to a second embodiment of the present invention is described. FIG. 7, FIG. 8 and FIG. 9 are timing charts that illustrate the driving method of this embodiment. Further, FIGS. 10A to 10C and FIGS. 11D to 11F show the drive polarity of each pixel of the liquid crystal display device of this embodiment. In FIGS. 10A to 10C and FIGS. 11D to 11F, 12×4 pixels 107 are illustrated, and the box represents one time-division driving unit. That is, in this embodiment, an example of three-time division driving of RGB pixels is described. FIG. 12 shows a wave form of a voltage charged to the pixel capacitor 108 of the driving method of this embodiment. In FIG. 7 to FIG. 9, RSW1, GSW1, BSW1, RSW2, GSW2, and BSW2 represent switch control pulses to write a drive voltage to each of RGB pixels, and Sm (m=6N−5 to 6N) represents a source drive polarity. Further, in FIGS. 10A to 10C and FIGS. 11D to 11F, the white rectangle represents a drive polarity of a positive polarity, and the hashed rectangle represents a pixel applied with a negative drive polarity. The numerals in FIGS. 10A to 10C and FIGS. 11D to 11F denote the time-division driving order of the plural pixels 107. Incidentally, driving method of this embodiment is applicable to the liquid crystal display device 100 described in the first embodiment, so description of the liquid crystal display device is omitted.

As shown in FIG. 7 to FIG. 9, according to the present invention, in a one selection period of one gate line, the time-division driving order of the plural pixels 107 connected to the gate line is changed in accordance with a frame. That is, the time-division driving order of the plural pixels 107 is changed to the order in a previous frame in accordance with a frame. Then, some of the plural pixels 107 are driven at the first timing in the one selection period. In this embodiment, the pixels are driven at the first timing in one selection period. That is, in one selection period of the gate line, the pixel 107 to which the drive voltage is first written is changed in accordance with the frame. In this embodiment, plural pixels 107 are driven at the first timing in one selection period in a period corresponding to as many frames as the number of time division. The pixel 107 to which the drive voltage is first written in one selection period of the gate line is changed in accordance with the frame. That is, the pixels 107 connected to the same gate line are supplied with a drive voltage at the first timing in a selection period of the gate line in any frame in a period corresponding to as many frames as the number of time division.

Further, the pixel 107 to which the drive voltage is first written is only driven with an inverted polarity with respect to the polarity of a drive voltage of a previous frame of the pixel 107. That is, a polarity of the drive voltage supplied to the pixel 107 to which the drive voltage is first written is inverted with respect to the polarity of the drive voltage supplied to a previous frame of the pixel 107.

Further, the target pixel 107 driven at a timing subsequent to the pixel 107 to which the drive voltage is first written is driven with the same polarity as a polarity of a frame previous to the target pixel 107. That is, a polarity of the drive voltage supplied to the target pixel 107 other than the pixel 107 to which the drive voltage is first written is the same as the polarity of the drive voltage supplied to the previous frame of the target pixel 107.

To be specific, as shown in FIG. 7, the pixels are driven in a time-division manner in the first frame in a selection period of an n-th line, an (n+1) th line, and an (n+2) th line in the order of R pixel→G pixel→B pixel. Thus, in the first frame, the R pixel is supplied with a drive voltage at the first timing in one selection period. Then, in the one selection period, after the completion of writing a drive voltage to the R pixel, the G pixel and the B pixel are successively supplied with a drive voltage. Thus, as shown in FIG. 10A, in the first frame, the pixel electrode is supplied with a drive voltage of a predetermined polarity in the order of R, G, and B.

Then, in the second frame subsequent to the first frame, the time-division driving order of the first frame is changed. Pixels are driven in a selection period of an n-th line, an (n+1)th line, and an (n+2)th line in the order of G pixel→B pixel→R pixel. Thus, in the second frame, the G pixel is supplied with a drive voltage at the first timing in one selection period. Then, after the completion of writing a drive voltage to the G pixel, the drive voltage is supplied to the B pixel and R pixel in the one selection period. Further, the G pixel 107 to which a drive voltage is written first is only driven with an inverted polarity with respect to the polarity of the previous first frame of the pixel 107. That is, a polarity of the drive voltage supplied to the G pixel 107 to which the drive voltage is written first is inverted with respect to the polarity of the drive voltage of the first frame of the G pixel.

Further, the B pixel 107 driven at a timing subsequent to the G pixel 107 to which the drive voltage is written first is driven with an inverted polarity with respect to the polarity of a previous frame of the B pixel 107. Thus, a polarity of the drive voltage supplied to the B pixel 107 is the same as the polarity of the previous frame of the B pixel. Further, the R pixel 107 driven at a timing subsequent to the B pixel 107 is driven with the same polarity as that of a previous first frame of the R pixel 107. Thus, a polarity of the drive voltage supplied to the R pixel 107 is the same as that of the drive voltage supplied to the R pixel in the first frame. That is, in the second frame, a polarity of the drive voltage supplied to the R and B pixels 107 other than the G pixel 107 to which the drive voltage is first written is the same as that of the drive voltage supplied to the previous first frame of the R and B pixel 107. Thus, as shown in FIG. 10B, second frame, the pixel electrodes are successively supplied with a drive voltage of a predetermined polarity in the order of G, B, and R.

As described above, in the second frame, in one selection period of the gate line, the G pixel 107 to which the drive voltage is written first is only driven with an inverted polarity with respect to the polarity of the previous first frame of the G pixel 107. That is, in one selection period, the B and R pixels that are subsequently driven are driven without inverting a polarity of the drive voltage. Hence, a drive voltage of the G pixel 107 to which a voltage has been written first and held is not influenced by a coupling the parasitic capacitance 111 between adjacent pixels even if a drive voltage is applied to adjacent B and R pixels.

Then, as shown in FIG. 8, in the third frame subsequent to the second frame, the time-division driving order of the second frame is changed. In a selection period of an n-th line, an (n+1)th line, and an (n+2)th line, the pixels are driven in the order of B pixel→R pixel→G pixel. Thus, in the third frame, the B pixel is supplied with the drive voltage at the first timing in one selection period. Then, in the one selection period, after the completion of writing a drive voltage to the B pixel, the R pixel and the G pixel are successively supplied with a drive voltage. Further, the B pixel 107 to which the drive voltage is written first is only driven with an inverted polarity with respect to a polarity of the previous second frame of the pixel 107. That is, the B pixel 107 to which the drive voltage is written with an inverted polarity with respect to the polarity of the drive voltage supplied first to the second frame of the B pixel.

Further, the R pixel 107 driven at a timing subsequent to the B pixel 107 to which the drive voltage is written first is driven with the same polarity as that of the previous second frame of the R pixel 107. Thus, a polarity of the drive voltage supplied to the R pixel 107 is the same as that of the drive voltage supplied to the second frame of the R pixel. Further, the G pixel 107 driven at a timing subsequent to the R pixel 107 is driven with the same polarity as that of the previous second frame of the G pixel 107. Thus, a polarity of the drive voltage supplied to the G pixel 107is the same as the polarity of the drive voltage supplied to the G pixel in the second frame. That is, in the third frame, a polarity of the drive voltage supplied to the R and G pixels 107 other than the B pixel 107 to which the drive voltage is written first is the same as a polarity of the drive voltage supplied to the previous second frame of the R and G pixel 107. Thus, as shown in FIG. 10C, in the third frame, the pixel electrodes are supplied with a drive voltage of a predetermined polarity in the order of B, R, and G.

As described above, in the third frame, in one selection period of the gate line, the B pixel 107 to which the drive voltage is written first is only driven with an inverted polarity with respect to the polarity of a voltage supplied to the B pixel 107 of the previous first frame. That is, in one selection period, a polarity of the drive voltage is not inverted upon writing a voltage to the R and G pixels that are subsequently driven in a time-division manner. Hence, a drive voltage of the B pixel 107 to which a voltage has been written first and held is not influenced by a coupling the parasitic capacitance 111 between adjacent pixels even if a drive voltage is applied to adjacent R and G pixels. Further, a polarity of the pixel 107 is inverted in accordance with a frame, so all pixels can be AC driven.

Further, in a third frame, the B pixel 107 is driven first in one selection period, so a polarity of the drive voltage supplied to the B pixel 107 is inverted with respect to that of the second frame. Hence, the voltage of the B pixel 107 is largely changed. Along with the change, the pixel voltage held in the R pixel and G pixel in the previous second frame is changed due to an influence of a coupling capacitance of the parasitic capacitance 111. However, in the selection period, the R pixel 107 is supplied with a predetermined drive voltage at a second timing subsequent to the drive timing B of the pixel 107. As a result, variations in pixel voltage of the R pixel 107 are cancelled out. At this time, a drive polarity of the R pixel 107 is the same as that of the previous second frame, so a voltage of the R pixel 107 is changed little. Thus, variations in the voltage of the R pixel 107 influence the pixel voltage of the other G and B pixels 107. Further, likewise, in the selection period, the G pixel 107 is supplied with a desired drive voltage at a third timing subsequent to the drive timing of the R pixel 107. Hence, variations in pixel voltage of the G pixel 107 are cancelled out. At this time, the drive polarity of the G pixel 107 is the same as that of the drive polarity of the previous second frame, so the voltage of the G pixel 107 are changed little. Thus, variations in voltage of the G pixel 107 influence the pixel voltage of the R and B pixels 107.

Then, as shown in FIG. 8 and FIG. 9, in the fourth frame to the sixth frame, similar to the first frame to the third frame, in one selection period of one gate line, plural pixels 107 are driven at the first timing in one selection period by changing the time-division driving order of the plural pixels 107 connected to the gate line in accordance with a frame. Further, the pixel 107 to which the drive voltage is first written is only driven with an inverted polarity with respect to a polarity of a drive voltage of a previous frame of the pixel 107. Thus, as shown in FIGS. 11D to 11F, the polarity of the frame is changed. As a result, after the completion of driving the sixth frame, in subsequent seventh frame, the time-division driving order and drive polarity thereof is returned to that of the first frame, and the same operation is repeated.

As described above, the time-division driving order of the plural pixels 107 is determined by each frame corresponding to the number of time division. That is, in this embodiment, since the number of time division is 3, so the order is determined every 3 frames. To be specific, in the first to third frame, the RGB pixels 107 are driven in the order of R→G→B in the first frame, in the order of G→B→R in the second frame, and in the order of B→R→G in the third frame. Then, in subsequent 3 frames, the fourth to sixth frames, the driving order of the pixels 107 in the first to third frames is employed. To be specific, in the fourth to sixth frame, the RGB pixels 107 are driven in the order of R→G→B in the fourth frame, in the order of G→B→R in the fifth frame, and in the order of B→R→G in the sixth frame. Then, in subsequent 3 frames, the fourth to sixth frames, the driving order of the pixels 107 in the first to third frames is employed.

According to such driving method, a waveform of a pixel voltage of the pixel capacitor 108 as shown in FIG. 12 is obtained. In FIG. 12, VR, VG, and VB represent a pixel voltage of each of the RGB pixels capacitor 108. As shown in FIG. 12, in the case of supplying a drive voltage, a coupling capacitance of the parasitic capacitance 111 between the adjacent pixel capacitors 108 causes changes in pixel voltage of the pixel capacitor 108 to which a voltage is first written; this problem can be solved. Incidentally, the drive voltage waveform is such that the maximum drive voltage is applied to the R and B pixels; the voltage is set equal to the common voltage such that 0 V is applied to the G pixel.

As description about the equivalent circuit of the related art as shown in FIG. 19, in this embodiment, an influence of the coupling parasitic capacitance varies depending on voltage changes ΔVP and ΔVQ of adjacent pixels. That is, variations due to an influence of a coupling capacitance of the parasitic capacitance 111 of the drive voltage written to the pixel capacitor 108 are expressed as follows on the assumption that R, G, and B pixel capacitors 108 have the same capacitance value CL, and the parasitic capacitance 111 has a capacitance value CP.

(ΔVR+ΔVB)×(CP+CL)/(CP+3CL).

As described above, according to the present invention, voltage changes of the pixels adjacent to the pixel capacitor 108 are as follows: ΔVR=0, ΔVB=0G. Thus, variations of the drive voltage held in the G the pixel capacitor 108 are 0.

As described above, according to the present invention, if the pixel voltage is held in the pixel capacitor, variations in write voltage to the adjacent pixel are suppressed. Therefore, a coupling capacitance between adjacent pixel capacitors due to the parasitic capacitance 111 between adjacent pixels influences the pixel voltage held in the pixel capacitor to lower a display quality; this problem can be solved. In particular, a driving method of the present invention is very effective to drive pixels with a frame period and suppress a coupling capacitance between pixel capacitors with a polarity inverting at an interval corresponding to an integral multiple of the frame period.

As described above, a method of driving a display device of the present invention changes the time-division driving order in accordance with a frame in a period corresponding to the number of time division to drive the plural pixels 107 connected to the same gate line at the first timing in one selection period of any frame. Then, the pixel to be driven first is only driven with an inverted polarity with respect to the polarity of a drive voltage of a previous frame, and pixels to be driven next are driven with the same polarity as the polarity of a drive voltage of a previous frame. As a result, an influence of a coupling the parasitic capacitance 111 between adjacent pixels can be suppressed.

Incidentally, this embodiment describes the case where the pixels are driven in a three-time division manner, but the present invention is not limited to this time-division driving method. The driving method of the present invention is applicable to time-division driving method that set the number of time division into two or more.

### Third Embodiment

Referring to FIG. 13, a display device according to a third embodiment of the present invention is described. FIG. 13 shows the configuration of the junction between the source driver and the liquid crystal display panel of the third embodiment. In FIG. 13, the same components as those of the first embodiment are denoted by identical reference numerals, and description thereof is omitted here. In this embodiment, 6 RGBRGB pixels adjacent and connected to the same gate line G are driven in a 6-time division manner. Thus, the source driver 103 of this embodiment differs from that of FIG. 3 in that one output circuit 110 is provided for 6 source lines.

As shown in FIG. 13, the source driver 103 includes plural output circuits 110. Further, the liquid crystal display panel 101 includes the multiplexer 105. The multiplexer 105 includes switches SW1, . . . , and SWx provided in accordance with the source lines S1, . . . , and Sx. In this embodiment, input terminals of the six switches SW are connected to one output terminal of the output circuit 110. For example, input terminals of the six switches SW1, SW2, SW3, SW4, SW5, and SW6 are connected to output terminal of one output circuit 110. Further, the output terminal of the switches SW are connected to the source lines S1, . . . , and Sx.

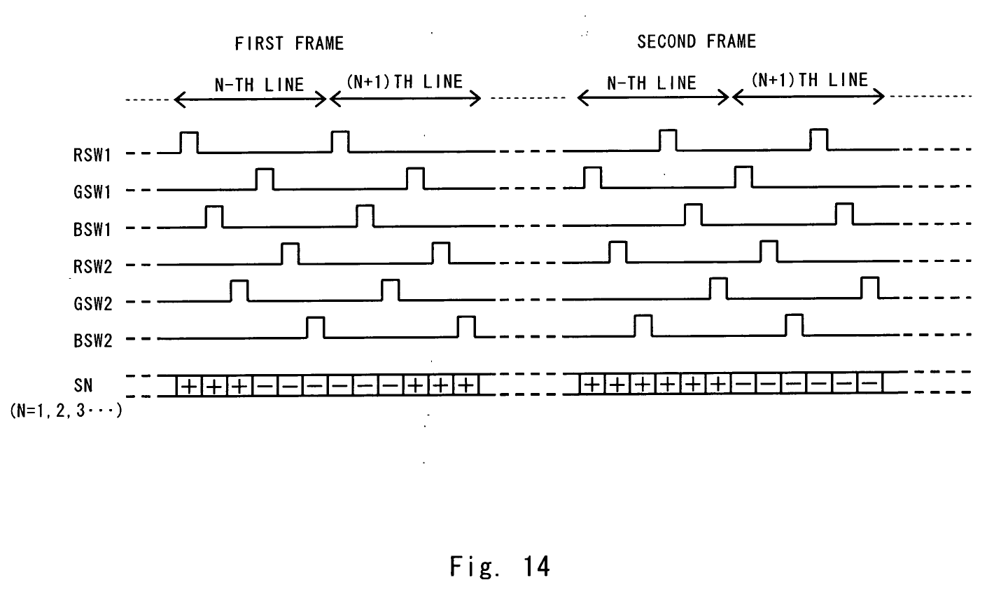

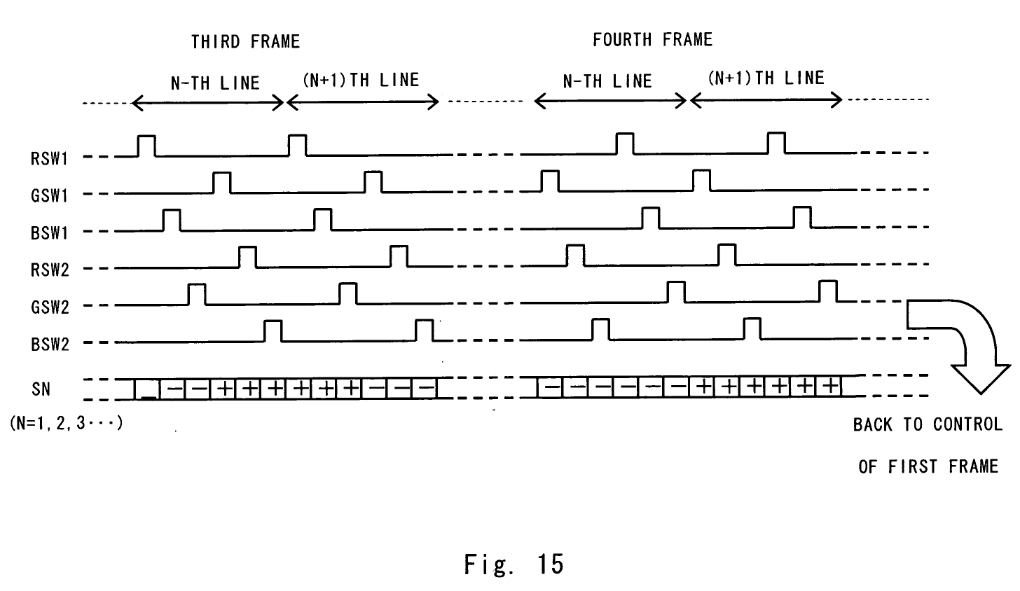

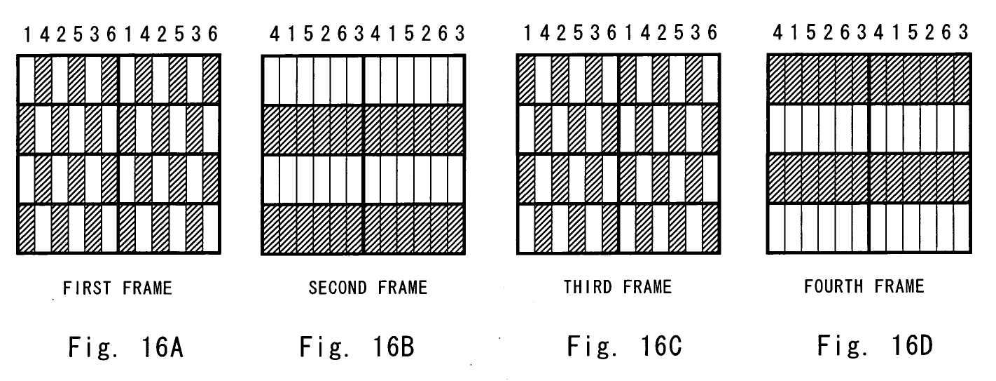

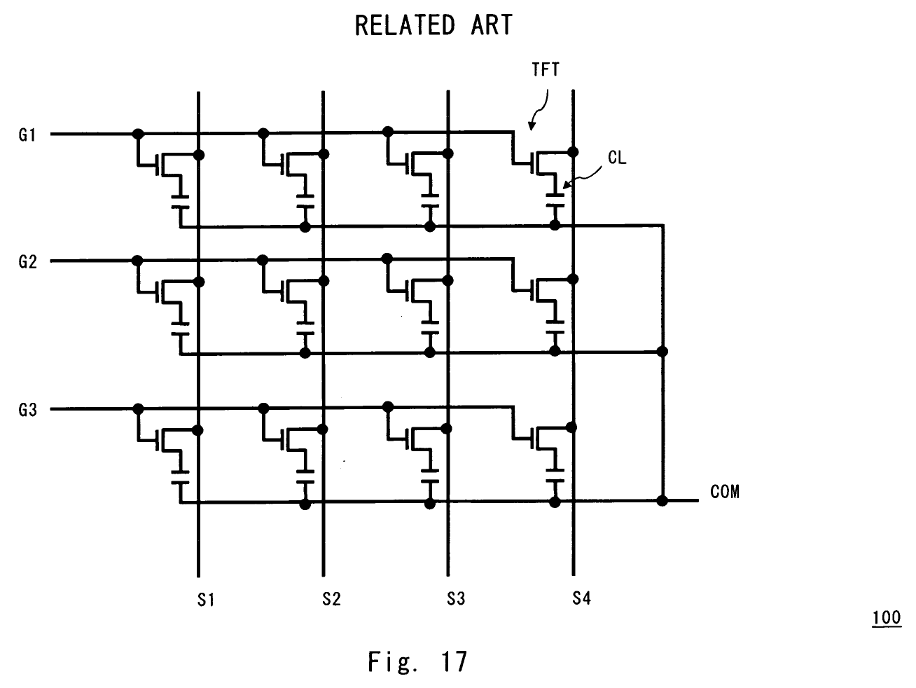

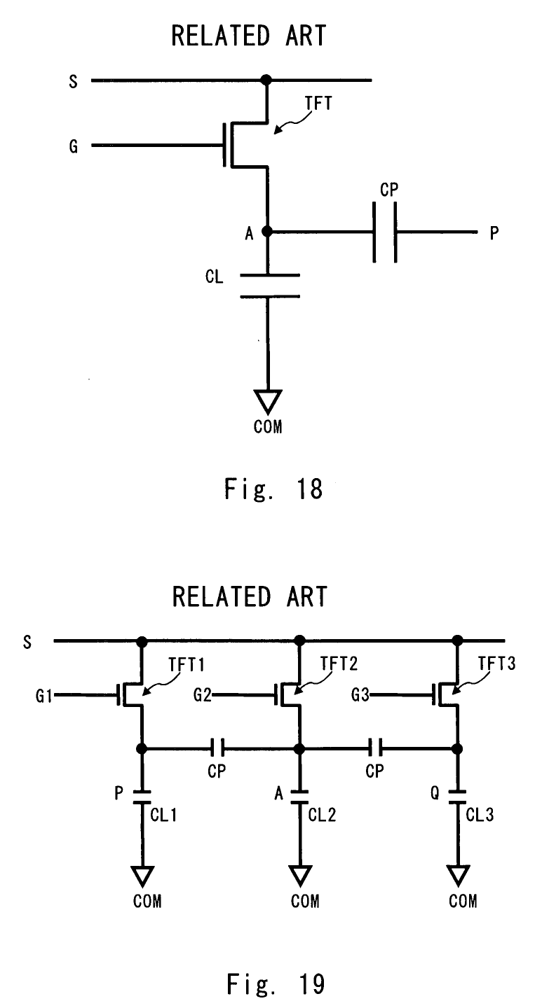

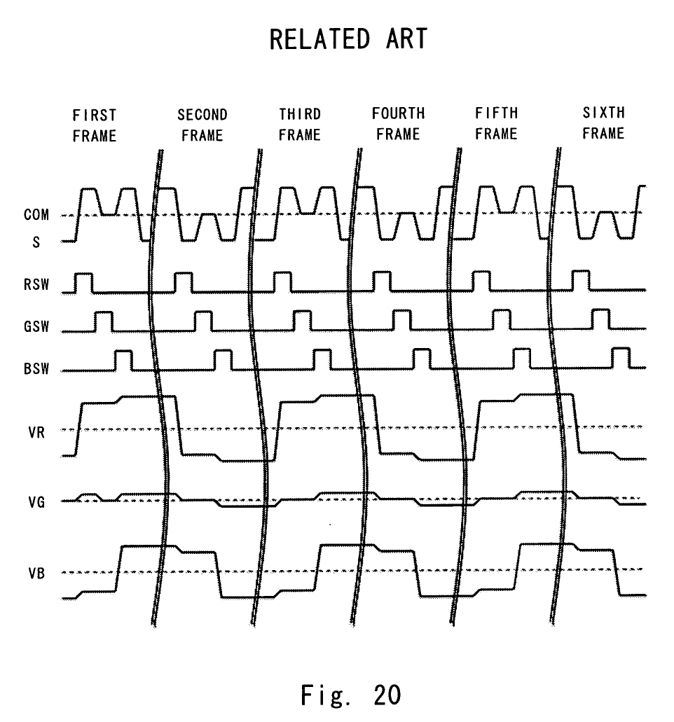

In this example, a driving method of this embodiment is described with reference to FIG. 14, FIG. 15, FIGS. 16A to 16D. FIG. 14 and FIG. 15 are timing charts illustrating the driving method of this embodiment. Further, FIGS. 16A to 16D show the drive polarity of each pixel of the liquid crystal display device of this embodiment. In FIGS. 16A to 16D, 12×4 pixels 107 are illustrated, and the box represents the time-division driving unit. That is, in this embodiment, adjacent 6 RGB pixels are driven in a 6-time division manner. In FIG. 14 and FIG. 15, RSW1, GSW1, BSW1, RSW2, GSW2, and BSW2 represent switch control pulses to write a drive voltage to each of RGB pixels, and Sm (m=6N−5 to 6N) represents a source drive polarity. Further, in FIGS. 16A to 16D, the white rectangle represents a drive polarity of a positive polarity, and the hashed rectangle represents a pixel applied with a negative drive polarity. The numerals in FIGS. 16A to 16D denote the time-division driving order of the plural pixels 107. Hereinafter, adjacent six pixels (two RGB pixel groups) included in one time division driving unit are denoted by R1, G1, B1, R2, G2, B2.

As shown in FIG. 14 and FIG. 15, in the present invention, in one selection period of one gate line, the time-division driving order of the plural pixels 107 connected to the gate line is changed in accordance with the frame. That is, the time-division driving order of the plural pixels 107 is changed to the order in a previous frame in accordance with a frame. Then, some of the plural pixels 107 are driven at a first timing in the one selection period. In this embodiment, pixels are driven at the first timing in one selection period. That is, in one selection period of the gate line, the pixel 107 to which the drive voltage is first written is changed in accordance with a frame.

Then, the pixel 107 to which the drive voltage is first written with an inverted polarity with respect to a polarity of a drive voltage of a previous frame of the pixel 107. That is, a polarity of the drive voltage supplied to the pixel 107 to which the drive voltage is first written is inverted with respect to that of the previous frame of the pixel 107. Further, in this embodiment, in one selection period, if a voltage has been already written to a pixel adjacent to the target pixel 107, the target pixel 107 is driven with the same polarity as that of a frame previous to the target pixel 107. Then, the target pixel 107 driven at the second timing subsequent to the pixel 107 to which the drive voltage is first written is driven with the same polarity as that of a drive voltage of a previous frame of the target pixel 107.

To be specific, as shown in FIG. 14, in the first frame, in a selection period of the n-th line and the (n+1)th line, the pixels are driven in the order of R1→B1→G2→G1→R2→B2 in the time-division manner. Thus, in the first frame, the R1 pixel is supplied with a drive voltage at the first timing in one selection period. Then, in the one selection period, after the completion of writing a drive voltage to the R pixel, a drive voltage is supplied to the B1 pixel, G2 pixel, . . . , in order. As a result, in the first frame, a drive voltage of a predetermined polarity is supplied to the pixel electrodes in the order as shown in FIG. 16A.

Then, in the second frame subsequent to the first frame, the time-division driving order of the first frame is changed. The pixels are driven in the order of G1→R2→B2→R1→B1→G2 in a selection period of an n-th line and an (n+1)th line in a time-division manner. Thus, in the second frame, the G1 pixel is supplied with a drive voltage at the first timing in one selection period. Then, in the one selection period, after the completion of writing a drive voltage to the G1 pixel, the R2 pixel, B2 pixel, . . . are supplied with the drive voltage in order.

At this time, in one selection period of the gate line, if a voltage has been written to a pixel adjacent to the target pixel 107, the target pixel 107 is driven with the same polarity as that of the previous frame of the target pixel 107. In this example, a voltage has not been written to the B1 and G2 pixels adjacent to the R2 pixel that is driven next. Therefore, the R2 pixel can be driven with an inverted polarity with respect to the polarity of the R2 pixel in a previous frame. Then, a voltage has not yet written to the G2 and R1 pixels adjacent to the B2 pixel that is driven third. Thus, the B2 pixel can be driven with an inverted polarity with respect to that of the B2 pixel in a previous frame.

Further, a voltage has been already written to the G1 and B2 pixel adjacent to the R1 pixel that is driven fourth. Hence, the R1 pixel is driven at the same polarity as that of the R1 pixel in a previous frame. Then, a voltage has been written to the G1 and R2 pixels adjacent to the B1 pixel driven fifth. Hence, the B1 pixel is driven with the same polarity as that of the B1 pixel of the previous frame. Thus, in the second frame, pixel electrodes are supplied with a drive voltage of a predetermined polarity in the order as shown in FIG. 16B. Therefore, even if a drive voltage of a pixel to which the voltage has been written first and held is not influenced by a coupling the parasitic capacitance 111 between adjacent pixels even if a drive voltage is applied to adjacent pixels.

Subsequent third and fourth frames are driven in the same driving order as the first and second frames as shown in FIG. 15. As a result, a drive polarity of FIG. 16C and FIG. 16D is obtained. Thus, plural pixels are alternately driven with an inverted polarity with respect to the polarity of a drive voltage of a previous frame. Further, pixels adjacent to the pixel that is driven with the inverted polarity are driven with the same polarity as a polarity of a drive voltage of a previous frame. A polarity of the pixel 107 is changed in accordance with a frame, so all the pixels can be uniformly AC driven. As described above, the plural pixels are alternately driven with an inverted polarity with respect to a polarity of a drive voltage of a previous frame of the pixel, and a polarity is inverted at shorter intervals to thereby suppress flicker. Hence, after the completion of driving the fourth frame, in a subsequent fifth frame, the order and polarity are returned to the time-division driving order and drive polarity of the first frame, and then, this operation is repeated.

As described above, the time-division driving order of the plural pixels 107 is changed to the order in a previous frame in accordance with a frame. Then, if a voltage has been already written to a pixel adjacent to the target pixel 107, the target pixel 107 is driven with the same polarity as a polarity of a frame previous to the target pixel 107. Hence, even if a drive voltage is applied to adjacent pixels, variations in hold voltage can be suppressed.

Incidentally, in the case of driving a pixel not adjacent to the pixel to which a voltage has been already written, a polarity of the previous frame of the pixel may be inverted or not inverted.

It is apparent that the present invention is not limited to the above embodiment but may be modified and changed without departing from the scope and spirit of the invention.

What is claimed is:

1. A method of driving a display device to drive plural pixels arranged on the same line in a time-division manner in a driving period of the line, comprising:
changing a time-division driving order of a plurality of pixels to an order in a previous frame for each frame and driving predetermined pixels of the plurality of pixels at a first timing in the one driving period;
driving a first pixel driven at the first timing with an inverted polarity with respect to a polarity of a drive voltage of a previous frame; and
driving a second pixel adjacent to the first pixel out of the plurality of pixels, which is driven at a second timing after the first timing with the same polarity as the polarity of a drive voltage of a previous frame.

2. The method of driving a display device according to claim 1, wherein all of the pixels arranged on the line are driven on a one-by-one basis at the first timing during a period corresponding to as many frames as the number of time division.

3. The method of driving a display device according to claim 1, wherein only the first pixel is driven with an inverted polarity with respect to a polarity of a drive voltage of a previous frame.

4. The method of driving a display device according to claim 1, wherein the first timing is a first timing in one selection period.

5. The method of driving a display device according to claim 1, wherein a time-division driving order of the plurality of pixels is determined for each frame corresponding to the number of time division.

6. The method of driving a display device according to claim 1, wherein the plurality of pixels are alternately driven at an inverted polarity with respect to a polarity of a drive voltage of a previous frame.

7. The method of driving a display device according to claim 1, wherein if a pixel adjacent to a predetermined pixel is driven at the timing before a timing for driving the predetermined pixel during the one driving period, the predetermined pixel is driven 5 with the same polarity as the polarity of a drive voltage of a previous frame.

8. A display device, comprising:
a plurality of pixel electrodes arranged on the same line;
a plurality of signal lines connected to the plurality of pixel electrodes in a one-to-one correspondence; and
a driving circuit to change a time-division driving order of a plurality of signal lines to an order in a previous frame for each frame and driving predetermined signal lines of the plurality of signal lines at a first timing in the one driving period, drive a first signal line driven at the first timing with an inverted polarity with respect to a polarity of a drive voltage of a previous frame, and drive a second signal line adjacent to the first signal line out of the plurality of signal lines, which is driven at a second timing after the first timing with the same polarity as the polarity of a drive voltage of a previous frame.

9. The display device according to claim 8, wherein all of the signal lines arranged on the line are driven on a one-by-one basis at the first timing during a period corresponding to as many frames as the number of time division.

10. The display device according to claim 8, wherein the driving circuit supplies a drive voltage with an inverted polarity with respect to a polarity of the drive voltage in one driving period of the line of a previous frame of the first signal line to the first signal line.

11. The display device according to claim 8, wherein the first timing is a first timing in one selection period.

12. The display device according to claim 8, wherein a time-division driving order of the plurality of signal lines is determined for each frame corresponding to the number of time division.

13. The display device according to claim 8, wherein the plurality of signal lines are alternately supplied with a drive voltage with an inverted polarity with respect to a polarity of the drive voltage in one driving period of the line of a previous frame of the signal line.

14. The display device according to claim 8, wherein if a signal line adjacent to a predetermined signal line is driven at the timing before a timing for driving the predetermined signal line during the one driving period, the predetermined signal line is driven with the same polarity as the polarity of a drive voltage of a previous frame.
